(19) United States
(12) Patent Application Publication
(10) Pub. No.: US 2019/0357568 A1
(43) Pub. Date: Nov. 28, 2019

(54) FOOD PRODUCT AND METHOD OF MAKING SAID FOOD PRODUCT

(71) Applicant: Saeid Dehghani, Shiraz (IR)

(72) Inventor: Saeid Dehghani, Shiraz (IR)

(21) Appl. No.: 15/988,369

(22) Filed: May 24, 2018

(51) Int. Cl. A23G 9/42; A23G 9/34; A23G 3/48; A23G 3/42

(52) U.S. Cl. CPC A23G 9/42; A23G 9/34; A23G 9/04; A23G 3/42; A23G 3/48

(57) ABSTRACT

A composition of an herbal-based food product and method of making said food product, is disclosed. The food product comprises, one or more herbal distillates, one or more sweetening agents, Salep and one or more natural additives of predetermined composition. Further, the method of preparing the food product, comprises the steps of: (a) introducing herbal distillate or combination of herbal distillates in a receptacle, (b) preparing a mixture of one or more sweetening agents in Salep to a predetermined amount, (c) adding said mixture to the herbal distillates and mixing to a predetermined time for dissolving the mixture in the herbal distillates, and (d) adding and mixing one or more optional natural additives at step (c), thereby providing the food product in any one of hot, cold or mild nature.

### BACKGROUND OF THE INVENTION

Generally, frozen dessert products such as ice cream have been enjoyed by consumers for years. However, these products have not been considered to be nutritious products due to their frozen nature and higher level of fat. Many attempts have been made to develop nutritional-rich ice cream which retains its desirable taste. For instance, several attempts have been made to produce ice cream having low levels of fat. Often, these modified ice creams sacrifice taste for improved nutritional properties, which are not accepted by the end-consumers.

Methods for manufacturing and formulating ice cream are well known. In general, the methods involve the mixing of ingredients, followed by processing and freezing. Briefly, milk of varying fat proportions and/or hydrated milk powder is combined with cane sugar or derivatives and/or corn syrups, modified food starches, maltodextrins, stabilizing gums and emulsifiers. Ice cream with high levels of fat also include the addition of cream to the mix. After the ingredients are mixed, the material is pasteurized, homogenized and chilled. This process material preferably is stored for a period of time ranging from a few hours to 24 hours. After the storage step a flavoring component is added to the mixture, if desired. If chocolate ice cream is being prepared, cocoa is added in the first mixing step and does not need to be added after the storage. Following the flavoring step, the material is partially frozen, packaged and then completely frozen.

A prior art, U.S. Pat. No. 7,033,629 of Koss et al. discloses a method for preparing nutritional frozen desserts having palatable characteristics. Said patent also discloses a non-diary frozen dessert for lactose in-tolerant and diary allergic individuals. The frozen dessert comprises a base component derived from plant-based protein sources such as soy milk, almonds, lupin etc., artificial or natural sweeteners such as sugar, honey etc., and non-fruit flavoring agent such as ginger, rose, etc.

Known dessert compositions and methods for their preparation, ice cream or ice cream like food products could be generally divided into two groups. One group, inclusive of milk and the other group with exclusive of milk in terms of its composition. In said exclusive group, fruit concentrates or some additives were used as a replacement. These replacement ingredients for milk practically lack in smell and taste, and does not make any effective change in characteristics, nature and property of the food product. Further, this replacement ingredients and milk-based dessert products is also an unhealthy product, in terms of their fat level and its chemical contents.

Therefore, there exists a need for a nutritional rich and therapeutic based herbal food product, such as a new dessert product, that could overcome above-mentioned issues and ensures healthy food for the end-users. Further, there is a need for an efficient, eco-friendly and cost-effective method for producing said herbal-based food products.

### SUMMARY OF THE INVENTION

The present invention discloses a composition of an herbal-based food product and method of making said food product. In an embodiment, the food product is a dessert product, for example, ice cream, etc. The food product comprises, one or more herbal distillates, one or more sweetening agents, Salep and one or more natural additives of predetermined composition. In one embodiment, the composition of herbal distillates ranges from 70% to 80%. The composition of sweetening agents ranges from 15% to 25%. The composition of Salep ranges from 0.5% to 1%.

One aspect of the present disclosure is directed to a composition of a food product, comprising: (a) one or more herbal distillates; (b) one or more sweetening agents; (c) Salep, and (d) one or more natural additives. In one embodiment, the composition of herbal distillates ranges from 70% to 80%. In another embodiment, the composition of sweetening agents ranges from 15% to 25%. In one embodiment, the composition of Salep ranges from 0.5% to 1%. In another embodiment, the herbal distillates include any one or combination of Flixweed, Chia, Nigelia sativa, Thyme, Lavender, Willow, Orange blossom, Pussy Willow, Pennyroyal (Mentha pulegium), Eglantine (Rosa eglanteria, or R. rubiginosa), Fumitory, Dill, Rosewater, Alhagi. Crataegus, Tribulus terrestris, Myrtle, Eucalyptus, Chamomile, Chives, Trachyspermum, Liquorice, Populus, Tarooneh, Chicory, Valerian, Ginger, Cinnamon, Leaf of walnut, Costmary, green and black Cumin, Olive leaves, Savory, Dianthus, Alfafa, Oregano, Echium, Golpareh, Urtica, Coriander, and Kakato.

In one embodiment, the sweetening agents include any one or combination of diet sugar, natural distillates, herbal syrups, and fruit juices. In another embodiment, the natural additives include any one or combination of eatable food colors, flavoring agents, or preservatives. In a related embodiment, the herbal syrups include any one or combination of Strawberry syrup, Rose flower syrup, Barberry syrup, Aloe vera syrup, Chicory syrup, Fig syrup and Olive syrup.

Another aspect of the present disclosure is directed to a composition of a food product, comprising: (a) one or more herbal distillates ranges from 73% to 77%; (b) one or more sweetening agents ranges from 20% to 23%; (c) Salep of about 0.82%, and (d) one or more optional natural additives. In one embodiment, the herbal distillates include any one or combination of Flixweed, Chia, Nigelia sativa, Thyme, Lavender, Willow, Orange blossom, Pussy Willow, Pennyroyal (Mentha pulegium), Eglantine (Rosa eglanteria, or R. rubiginosa), Fumitory, Dill, Rosewater, Alhagi. Crataegus, Tribulus terrestris, Myrtle, Eucalyptus, Chamomile, Chives, Trachyspermum, Liquorice, Populus, Tarooneh, Chicory, Valerian, Ginger, Cinnamon, Leaf of walnut, Costmary, green and black Cumin, Olive leaves, Savory, Dianthus, Alfafa, Oregano, Echium, Golpareh, Urtica, Coriander, and Kakato. In another embodiment, the sweetening agents include any one or combination of diet sugar, natural distillates, herbal syrups, and fruit juices. In one embodiment, the natural additives include any one or combination of eatable food colors, flavoring agents, and preservatives.

In another embodiment, the herbal syrups include any one or combination of Strawberry syrup, Rose flower syrup, Barberry syrup, Aloe vera syrup, Chicory syrup, Fig syrup and Olive syrup. In a related embodiment, if the sweetening agent is diet sugar, the composition of herbal distillates is 76.38%, diet sugar is 22.81%, and Salep is 0.82%. In another related embodiment, if the sweetening agent is herbal syrup, the composition of herbal distillates is 76.38%, herbal syrup is 16.29% to 18.32%, and Salep is 0.82%. In another related embodiment, if the sweetening agent is fruit syrup, the composition of herbal distillates is 73.38%, fruit syrup is 19.29% to 21.32%, and Salep is 0.82%. In one embodiment, if the sweetening agent is fruit juices and distillates, the composition of herbal distillates and fruit juices is 73.38%, fruit syrup or distillates is 19.29% to 21.32%, and Salep is 0.82%.

Another aspect of the present disclosure is directed to a method of preparing a food product, comprising the steps of: (a) introducing herbal distillate or combination of herbal distillates in a receptacle; (b) preparing a mixture of one or more sweetening agents in Salep to a predetermined amount; (c) adding said mixture to the herbal distillates and mixing to a predetermined time for dissolving the mixture in the herbal distillates, and (d) adding and mixing one or more optional natural additives at step (c), thereby providing the food product in any one of hot, cold or mild nature. In one embodiment, the composition of herbal distillates ranges from 73% to 77%, sweetening agents ranges from 20% to 23%, Salep of 0.82%, and optional natural additives. In another embodiment, the sweetening agents include any one or combination of diet sugar, natural distillates, herbal syrups, and fruit juices.

In some embodiments, the herbal distillates include any one or combination of Flixweed, Chia, Nigelia sativa, Thyme, Lavender, Willow, Orange blossom, Pussy Willow, Pennyroyal (Mentha pulegium), Eglantine (Rosa eglanteria, or R. rubiginosa), Fumitory, Dill, Rosewater, Alhagi. Crataegus, Tribulus terrestris, Myrtle, Eucalyptus, Chamomile, Chives, Trachyspermum, Liquorice, Populus, Tarooneh, Chicory, Valerian, Ginger, Cinnamon, Leaf of walnut, Costmary, green and black Cumin, Olive leaves, Savory, Dianthus, Alfafa, Oregano, Echium, Golpareh, Urtica, Coriander, and Kakato.

In some embodiments, the sweetening agents include any one or combination of diet sugar, natural distillates, herbal syrups, and fruit juices. In some embodiments, the natural additives include any one or combination of eatable food colors, flavoring agents, or preservatives. In some embodiments, the herbal syrups include any one or combination of Strawberry syrup, Rose flower syrup, Barberry syrup, Aloe vera syrup, Chicory syrup, Fig syrup and Olive syrup.

In one embodiment, the composition of herbal distillates is 76.38%, diet sugar is 22.81%, and Salep is 0.82%, if the food product is prepared using diet sugar as a sweetening agent. In one embodiment, the composition of herbal distillates is 76.38%, herbal syrup is 16.29% to 18.32%, and Salep is 0.82%, if the food product is prepared using herbal syrup as a sweetening agent. In another embodiment, the composition of herbal distillates is 73.38%, fruit syrup is 19.29% to 21.32%, and Salep is 0.82%, if the food product is prepared using fruit syrup as a sweetening agent. In another embodiment, the composition of herbal distillates and fruit juices is 73.38%, fruit syrup or distillates is 19.29% to 21.32%, and Salep is 0.82%, if the food product is prepared using fruit juices and distillates as a sweetening agent.

Further, the method of preparing a food product, comprises the steps of: (a) introducing herbal distillate or combination of herbal distillates in a receptacle, (b) preparing a mixture of one or more sweetening agents in Salep to a predetermined amount, (c) adding said mixture to the herbal distillates and mixing to a predetermined time for dissolving the mixture in the herbal distillates, and (d) adding and mixing one or more optional natural additives at step (c), thereby providing the food product in any one of hot, cold or mild nature.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIG. 1 exemplarily illustrates a method of making a food product, according to an embodiment of the present invention.

### DETAILED DESCRIPTION

The present invention generally relates to a food product or composition and method of making said food composition. More specifically, the present invention relates to an herbal based food composition, for example, a dessert product, etc.

A description of embodiments of the present invention will now be given with reference to the figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present invention discloses a composition of an herbal-based food product and method of making said food product. In an embodiment, the food product is a non-milk-based dessert product, for example, ice cream, drinks or shakes etc. The food product could be consumed/used by a user, as a replacement for existing dessert products. The main component of the food product, according to the present invention, are herbal distillates, syrups, and other additives for enhancing smell, taste and herbal properties. The food product could be of different nature, properties and characteristics, for example, in hot, cold or mild in nature.

The food product comprises, one or more herbal distillates, one or more sweetening agents, Salep and one or more natural additives of predetermined composition. In one embodiment, the composition of herbal distillates ranges from 70% to 80%. The composition of sweetening agents ranges from 15% to 25%. The composition of Salep ranges from 0.5% to 1%. In some embodiments, the composition of the herbal distillates ranges from about 73% to about 77%, sweetening agents ranges from about 20% to about 23%, Salep of about 0.82%, and remaining constitutes one or more optional natural additives or preservatives.

In some embodiments, the herbal distillates include any one or combination of Flixweed, Chia, Nigelia sativa, Thyme, Lavender, Willow, Orange blossom, Pussy Willow, Pennyroyal (Mentha pulegium), Eglantine (Rosa eglanteria, or R. rubiginosa), Fumitory, Dill, Rosewater, Alhagi. Crataegus, Tribulus terrestris, Myrtle, Eucalyptus, Chamomile, Chives, Trachyspermum, Liquorice, Populus, Tarooneh, Chicory, Valerian, Ginger, Cinnamon, Leaf of walnut, Costmary, green and black Cumin, Olive leaves, Savory, Dianthus, Alfafa, Oregano, Echium, Golpareh, Urtica, Coriander, and Kakato. Table 1, shows some of the distillates, their nature and properties. The properties of the distillates show some of its therapeutic property and characteristics.

TABLE 1
Nature and Properties of Different Types of Distillates

| Type of | Nature of | |
|---|---|---|
| Distillates | Distillates | Properties |
| Thyme | Hot | Sedative, strengthening stomach |
| Lavender | Hot | Strengthening nerves, tranquilizer |
| Willow | Cold | Blood purification |
| Orange | Hot | Strengthening neurology, cheering |
| Blossom | | |
| Pussy | Mild | Strengthening nerves, anti-palpitation |
| Willow | | |
| Pennyroyal | Hot | Disinfectant, opening vascular |
| Eglantine | Hot | For kidney stone and strengthening stomach |
| Fumitory | Mild | Strengthening skin, tranquilizer, Appetizer |
| Dill | Hot | Fragrant, strengthening stomach, digesting food |
| Rosewater | Hot | Strengthening nerves, skin |
| Alhagi | Cold | Kidney stone and balladry stone, blood |
| | | purification |

In some embodiments, the sweetening agents include any one or combination of diet sugar, natural distillates, herbal syrups, and fruit juices. In some embodiments, the herbal syrups include any one or combination of Strawberry syrup, Rose flower syrup, Barberry syrup, Aloe vera syrup, Chicory syrup, Fig syrup and Olive syrup. In some embodiments, the natural additives include any one or combination of eatable food colors, flavoring agents, or preservatives. In some embodiments, the food product may comprise other natural and health-care ingredients, but not limited to, dry fruits such as grained berry, pieces of apricot, pieces of fig, kernel and different types of spices such as ginger and cinnamon.

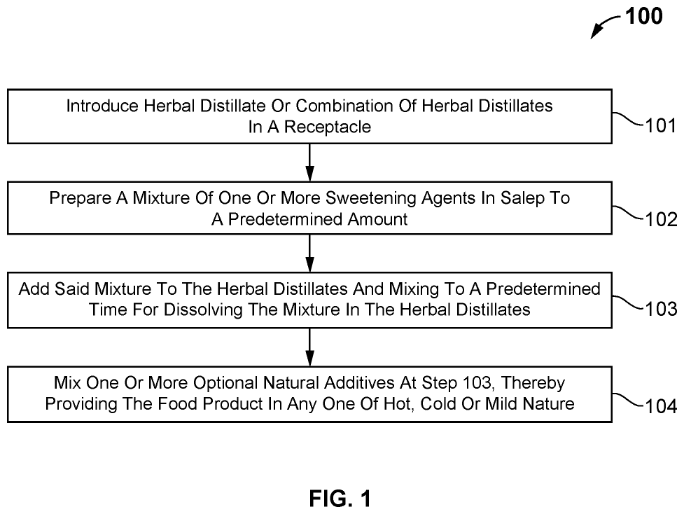

FIG. 1 exemplarily illustrates a method of making a food product, according to another embodiment of the present invention. In an embodiment, a method 100 of preparing the food product as described above, is also disclosed. In step 101, the method 100 comprises, introducing herbal distillate or combination of herbal distillates in a receptacle. In step 102, the method 100 comprises, preparing a mixture of one or more sweetening agents in Salep to a predetermined amount. In step 102, the method 100 further comprises, adding said mixture to the herbal distillates and mixing to a predetermined time for dissolving the mixture in the herbal distillates. In some embodiments, the method may avoid or use less amount of sweetening agent by mixing the distillates with fruit juices.

In step 104, the method 100 comprises, adding and mixing one or more optional natural additives, for example, eatable color, fruit pieces, different powders such a cinnamon powder, at step 103, thereby providing the food product in any one of hot, cold or mild nature. In some embodiments, the method 100, after step 104, incorporates or follows existing method of making ice creams or shakes or any other desserts, to provide final respective food products. In some embodiments, the food product could be produced using syrups, honey, and without using sugar directly. Salep in the composition of the food product, provides an amount of whitening, adhesion-flavored, and proprietary for blend composition in the food product. Different names and forms of this product that have different flavors include sap-loving, shandy, shanat, flora, new stylish drink types. In one example, the product produced is not ice cream because of the composition of the product; it can be made to have different flavors including pomegranate juice, Ardeh, Grape sap, palm sap. The product disclosed in the present disclosure may be considered as not ice cream and is branded as a Casheh-Casheh product.

In some embodiments, the food product is prepared with various properties by regular mixing of different distillates and syrup together or separately. In various embodiments, the food product is prepared by four modes, with purified industrial or diet sugar (brown sugar), syrups, distillates (without using sugar) and honey. In one embodiment, the composition of herbal distillates is 76.38%, diet sugar is 22.81%, and Salep is 0.82%, if the food product is prepared using diet sugar as a sweetening agent. In one embodiment, the composition of herbal distillates is 76.38%, herbal syrup is 16.29% to 18.32%, and Salep is 0.82%, if the food product is prepared using herbal syrup as a sweetening agent. In another embodiment, the composition of herbal distillates is 73.38%, fruit syrup is 19.29% to 21.32%, and Salep is 0.82%, if the food product is prepared using fruit syrup as a sweetening agent. In another embodiment, the composition of herbal distillates and fruit juices is 73.38%, fruit syrup or distillates is 19.29% to 21.32%, and Salep is 0.82%, if the food product is prepared using fruit juices and distillates as a sweetening agent.

According to the present invention, the main ingredient of the food product are herbal distillates and syrups, which provides various herbal properties, taste, flavors and aroma in different nature (cold, hot and mild). In some embodiments, the food product is prepared completely by herbal ingredients for different nature of people or users. The food product could be consumed as a recreational drink combined with traditional aspect and treatment or therapeutic feature for some diseases. In one embodiment, the food product is not limited to particular type of additive materials for said main ingredients, where any material or components could be considered for enhancing aroma, nature, taste and property. Further, the amount of fat in this food product is zero percentage and proven to be a healthy product due to its healthy nature, without any chemical additives and preservatives.

The food product according to the present invention, presents a new or substitute herbal based healthy product with an approximate different texture and nature to the existing dessert products. Further, this food product helps in orienting the people or consumers to consume healthier food product, which also possess different medicinal properties.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method.

Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein. While the above is a complete description of the preferred embodiments of the invention, various alternatives, modifications, and equivalents may be used. Therefore, the above description and the examples should not be taken as limiting the scope of the invention, which is defined by the appended claims.

1. A composition of a food product, comprising:
(a) one or more herbal distillates;
(b) one or more sweetening agents;
(c) Salep, and
(d) one or more natural additives.

2. The composition of claim 1, wherein the composition of herbal distillates ranges from 70% to 80%.

3. The composition of claim 1, wherein the composition of sweetening agents ranges from 15% to 25%.

4. The composition of claim 1, wherein the composition of Salep ranges from 0.5% to 1%.

5. The composition of claim 1, wherein the herbal distillates include any one or combination of Flixweed, Chia, Nigelia sativa, Thyme, Lavender, Willow, Orange blossom, Pussy Willow, Pennyroyal (Mentha pulegium), Eglantine (Rosa eglanteria, or R. rubiginosa), Fumitory, Dill, Rosewater, Alhagi. Crataegus, Tribulus terrestris, Myrtle, Eucalyptus, Chamomile, Chives, Trachyspermum, Liquorice, Populus, Tarooneh, Chicory, Valerian, Ginger, Cinnamon, Leaf of walnut, Costmary, green and black Cumin, Olive leaves, Savory, Dianthus, Alfafa, Oregano, Echium, Golpareh, Urtica, Coriander, and Kakato.

6. The composition of claim 1, wherein the sweetening agents include any one or combination of diet sugar, natural distillates, herbal syrups, and fruit juices.

7. The composition of claim 1, wherein the natural additives include any one or combination of eatable food colors, flavoring agents, or preservatives.

8. The composition of claim 6, wherein the herbal syrups include any one or combination of Strawberry syrup, Rose flower syrup, Barberry syrup, Aloe vera syrup, Chicory syrup, Fig syrup and Olive syrup.

9. A composition of a food product, comprising:
(a) one or more herbal distillates ranges from 73% to 77%;
(b) one or more sweetening agents ranges from 20% to 23%;
(c) Salep of about 0.82%, and
(d) one or more optional natural additives.

10. The composition of claim 9, wherein the herbal distillates include any one or combination of Flixweed, Chia, Nigelia sativa, Thyme, Lavender, Willow, Orange blossom, Pussy Willow, Pennyroyal (Mentha pulegium), Eglantine (Rosa eglanteria, or R. rubiginosa), Fumitory, Dill, Rosewater, Alhagi. Crataegus, Tribulus terrestris, Myrtle, Eucalyptus, Chamomile, Chives, Trachyspermum, Liquorice, Populus, Tarooneh, Chicory, Valerian, Ginger, Cinnamon, Leaf of walnut, Costmary, green and black Cumin, Olive leaves, Savory, Dianthus, Alfafa, Oregano, Echium, Golpareh, Urtica, Coriander, and Kakato.

11. The composition of claim 9, wherein the sweetening agents include any one or combination of diet sugar, natural distillates, herbal syrups, and fruit juices.

12. The composition of claim 9, wherein the natural additives include any one or combination of eatable food colors, flavoring agents, and preservatives.

13. The composition of claim 9, wherein the herbal syrups include any one or combination of Strawberry syrup, Rose flower syrup, Barberry syrup, Aloe vera syrup, Chicory syrup, Fig syrup and Olive syrup.

14. The composition of claim 11, wherein if the sweetening agent is diet sugar, the composition of herbal distillates is 76.38%, diet sugar is 22.81%, and Salep is 0.82%.

15. The composition of claim 11, wherein if the sweetening agent is herbal syrup, the composition of herbal distillates is 76.38%, herbal syrup is 16.29% to 18.32%, and Salep is 0.82%.

16. The composition of claim 11, wherein if the sweetening agent is fruit syrup, the composition of herbal distillates is 73.38%, fruit syrup is 19.29% to 21.32%, and Salep is 0.82%.

17. The composition of claim 11, wherein if the sweetening agent is fruit juices and distillates, the composition of herbal distillates and fruit juices is 73.38%, fruit syrup or distillates is 19.29% to 21.32%, and Salep is 0.82%.

18. A method of preparing a food product, comprising the steps of:
(a) introducing herbal distillate or combination of herbal distillates in a receptacle;
(b) preparing a mixture of one or more sweetening agents in Salep to a predetermined amount;
(c) adding said mixture to the herbal distillates and mixing to a predetermined time for dissolving the mixture in the herbal distillates, and
(d) adding and mixing one or more optional natural additives at step (c), thereby providing the food product in any one of hot, cold or mild nature.

19. The method of claim 18, wherein the composition of herbal distillates ranges from 73% to 77%, sweetening agents ranges from 20% to 23%, Salep of 0.82%, and optional natural additives.

20. The method of claim 18, wherein the sweetening agents include any one or combination of diet sugar, natural distillates, herbal syrups, and fruit juices.
